(19) United States
(12) Patent Application Publication
(10) Pub. No.: US 2021/0149813 A1
(43) Pub. Date: May 20, 2021

(54) DATA WRITE SYSTEM AND METHOD

(71) Applicant: Realtek Semiconductor Corporation, Hsinchu (TW)

(72) Inventors: Yen-Ju Lu, Hsinchu (TW); Chao-Wei Huang, Hsinchu (TW)

(21) Appl. No.: 16/872,659

(22) Filed: May 12, 2020

(30) Foreign Application Priority Data
Nov. 18, 2019 (TW) 108141833

(51) Int. Cl. G06F 12/0895; G06F 12/123

(52) U.S. Cl. CPC G06F 12/0895; G06F 2212/1008; G06F 12/124

(57) ABSTRACT

A data write system includes a main memory, a cache memory, and a core processing circuit. The main memory includes a restricted region and a non-restricted region. The cache memory is coupled to the main memory. The cache memory includes multiple ways. The core processing circuit is coupled to the cache memory and includes a logic circuit. The logic circuit is configured to select one of the ways as a selected way according to an access address of the main memory, the restricted region, and mode setting information, to write data corresponding to the access address into the selected way.

### RELATED APPLICATIONS

This application claims priority to Taiwanese Application Serial Number 108141833, filed Nov. 18, 2019, which is herein incorporated by reference.

### BACKGROUND

### Technical Field

The present disclosure relates to a cache technology. More particularly, the present disclosure relates to a data write system and a data write method suitable for a cache memory.

### Description of Related Art

In memory technology, the cache memory can work in coordination with a main memory. Compared to the main memory, the operation speed of the cache memory is faster. Accordingly, with the cache memory, the operation efficiency of the overall system is increased, in which the cache hit rate and the cache miss penalty are key factors to the operation efficiency of the overall system.

### SUMMARY

One embodiment of the present disclosure is related to a data write system. The data write system includes a main memory, a cache memory, and a core processing circuit. The main memory includes a restricted region and a non-restricted region. The cache memory is coupled to the main memory.

The cache memory includes multiple ways. The core processing circuit is coupled to the cache memory and includes a logic circuit. The logic circuit is configured to select one of the ways as a selected way according to an access address of the main memory, the restricted region, and mode setting information, to write data corresponding to the access address into the selected way.

One embodiment of the present disclosure is related to a data write method. The data write method includes the following steps: reading base address information and top address information by a logic circuit of a core processing circuit, to determine a restricted region and a non-restricted region of a main memory; and selecting one of multiple ways of a cache memory as a selected way according to an access address of the main memory, the restricted region, and mode setting information by the logic circuit, to write data corresponding to the access address into the selected way.

As shown in the above embodiments, the data write system and the data write method of the present disclosure can prevent data in the restricted region and data in the non-restricted region from interfering each other.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a data write system according to some embodiments of the present disclosure.

FIG. 2 is a schematic diagram illustrating registers, a logic circuit, and a cache memory according to some embodiments of the present disclosure.

FIG. 3 is a schematic diagram illustrating mode setting information according to some embodiments of the present disclosure.

FIG. 4 is a flow diagram illustrating a setting method of setting the registers in FIG. 1 according to some embodiments of the present disclosure.

FIG. 5 is a flow diagram illustrating an operation method of a data write system according to some embodiments of the present disclosure.

FIG. 6 is a schematic diagram illustrating operations of the operation method in FIG. 5 according to some embodiments of the present disclosure.

FIG. 7 is a flow diagram illustrating a data write method according to some embodiments of the present disclosure.

### DETAILED DESCRIPTION

Reference is now made in detail to the present embodiments of the disclosure, examples of which are illustrated in the accompanying drawings. Wherever possible, the same reference numbers are used in the drawings and the description to refer to the same or like parts. The embodiments below are described in detail with the accompanying drawings, but the examples provided are not intended to limit the scope of the disclosure covered by the description. The structure and operation are not intended to limit the execution order. Any structure regrouped by elements, which has an equal effect, is covered by the scope of the present disclosure.

In the present disclosure, “connected” or “coupled” may be referred to “electrically connected” or “electrically coupled.” “Connected” or “coupled” may also be referred to operations or actions between two or more elements.

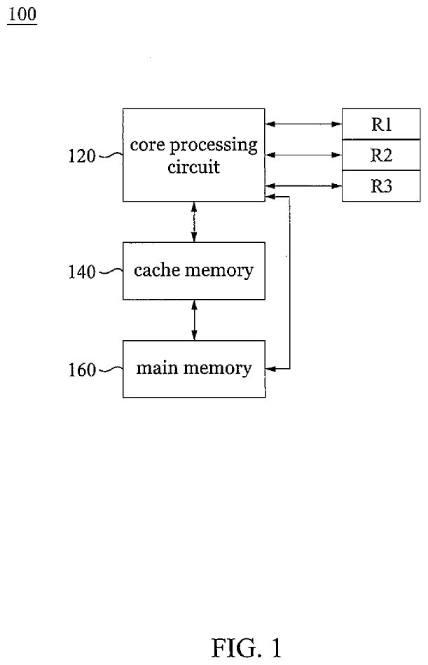

Reference is made to FIG. 1. FIG. 1 is a schematic diagram illustrating a data write system 100 according to some embodiments of the present disclosure. As illustrated in FIG. 1, the data write system 100 includes a core processing circuit 120, a cache memory 140, a main memory 160, and registers R1-R3.

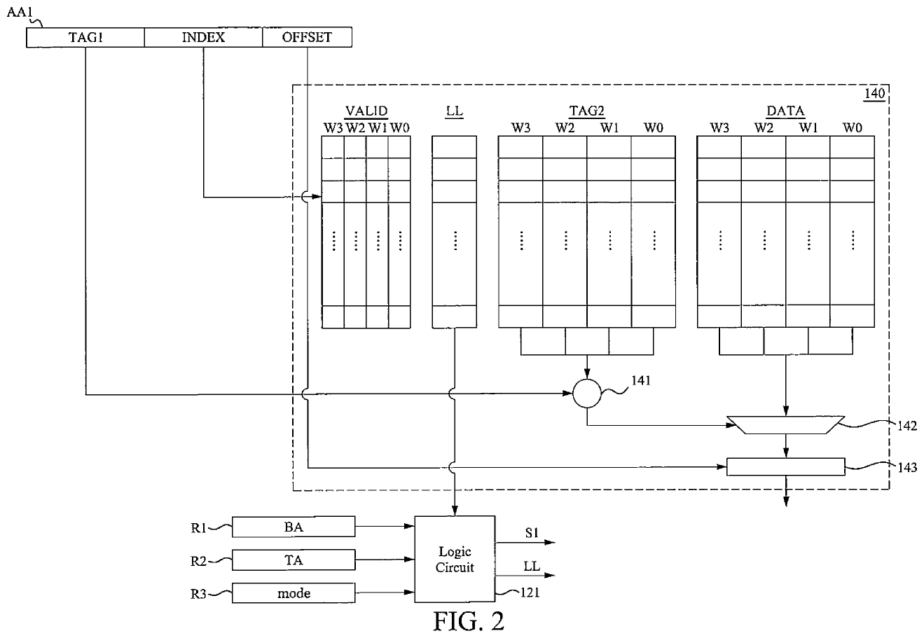

The registers R1-R3 are coupled to the core processing circuit 120. The core processing circuit 120 is coupled to the cache memory 140 and the main memory 160. The cache memory 140 is coupled to the main memory 160. In some embodiments, the core processing circuit 120 includes a logic circuit (for example, a logic circuit 121 in FIG. 2).

In some embodiments, for increasing the operation efficiency, data commonly used is stored in the cache memory 140, such that the core processing circuit 120 can reads the data from the cache memory 140 directly.

References are made to FIG. 1 and FIG. 2. FIG. 2 is a schematic diagram illustrating the registers R1-R3, the logic circuit 121, and the cache memory 140 according to some embodiments of the present disclosure.

As illustrated in FIG. 2, the cache memory 140 includes multiple ways W0-W3. The quantity of the ways is merely for illustration, and various quantities are within contemplated scope of the present disclosure.

When the core processing circuit 120 receives a reading command to read data in an access address AA1, the core processing circuit 120 can read the cache memory 140 according to the access address AM .

As illustrated in FIG. 2, the access address AA1 includes a tag field TAG1, an index field INDEX, and an offset field OFFSET. According to the index field INDEX, a corresponding row is determined. By comparing multiple tag information TAG2 of the corresponding row with the tag field TAG1 respectively, corresponding data DATA can be determined. A corresponding bit (or corresponding bits) of the corresponding data DATA is determined.

For example, if the index field INDEX indicates the third row, a comparator circuit 141 compares the tag information TAG2 in the third row with the tag field TAG1. If the tag information TAG2 in the way W2 and the tag field TAG1 are matched, it is referred as “cache hit.” In other words, data to be read exists in the cache memory 140. Accordingly, a selector circuit 142 outputs a corresponding bit of data DATA in the way W2 according to the offset field OFFSET to an output circuit 143. Then, the output circuit 143 outputs the corresponding bit of the data DATA in the way W2. In some embodiments, the comparator circuit 141 is implemented by a comparator, but the present disclosure is not limited thereto. In some embodiments, the selector circuit 142 is implemented by a multiplexer, but the present disclosure is not limited thereto.

If the tag information TAG2 in the third row and the tag field TAG1 are not matched, it is referred as “cache miss.” In other words, data to be read does not exist in the cache memory 140.

Selection information LL is configured to indicate a mechanism of how to choose a written address. In some embodiments, the mechanism is the Least Recently Used (LRU) algorithm, but the present disclosure is not limited thereto. In other words, in these embodiments, if “cache miss” occurs, the LRU algorithm is used to load the data to be read from the main memory 160 into the cache memory 140 by using the LRU algorithm. In addition, valid information VALID is configured to indicate whether the corresponding data is valid.

The register R1 is configured to store base address information BA. The register R2 is configured to store top address information TA. A restricted region of the main memory 160 is defined by the base address information BA and the top address information TA. Other portions of the main memory 160 are non-restricted regions. The register R3 is configured to store mode setting information MODE. The mode setting information MODE records whether each of the ways W0-W3 is a restricted way or a non-restricted way.

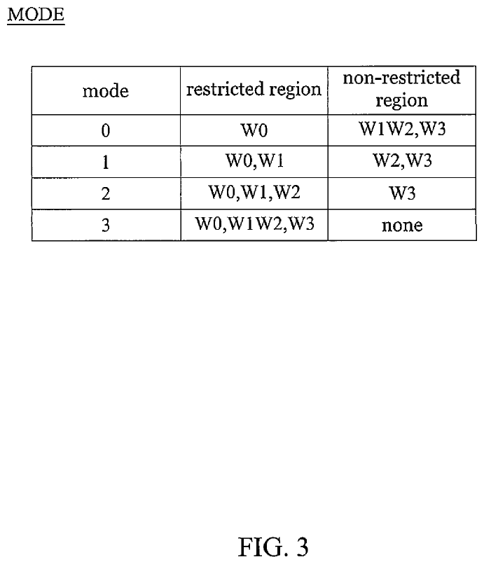

Reference is made to FIG. 3. FIG. 3 is a schematic diagram illustrating the mode setting information MODE according to some embodiments of the present disclosure. As illustrated in FIG. 3, the mode setting information MODE includes four modes. In a mode 0, the way W0 is a restricted way and ways W1-W3 are non-restricted ways. In mode 1, the ways W0-W1 are restricted ways, and the ways W2-W3 are non-restricted ways. In mode 2, the ways W0-W2 are restricted ways, and the ways W3 is a non-restricted way. In mode 3, the ways W0-W3 are restricted ways. The implementation of the mode setting information MODE above is merely for illustration. Various implementations of the mode setting information MODE are within contemplated scope of the present disclosure.

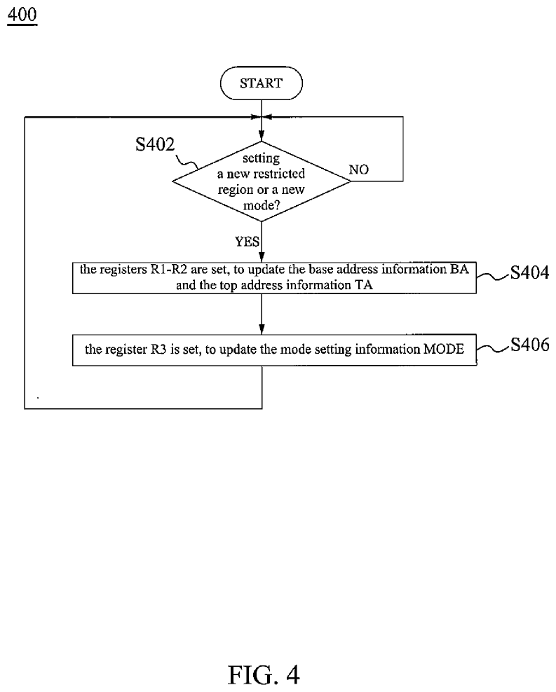

Reference is made to FIG. 4. FIG. 4 is a flow diagram illustrating a setting method 400 of the registers R1-R3 in FIG. 1 according to some embodiments of the present disclosure. As illustrated in FIG. 4, the setting method 400 includes operations S402, S404 and S406. In operation S402, it is determined whether there is a need to set a new restricted region or a new mode. In other words, it is determined whether there is a need to update the restricted region of the main memory 160 in FIG. 1 or the mode setting information MODE in the register R3. If yes, the setting method 400 goes to operation S404. In operation S404, the registers R1-R2 are set to update the base address information BA and the top address information TA. Then, the setting method 400 goes to operation S406. In operation S406, the register R3 is set, to update the mode setting information MODE.

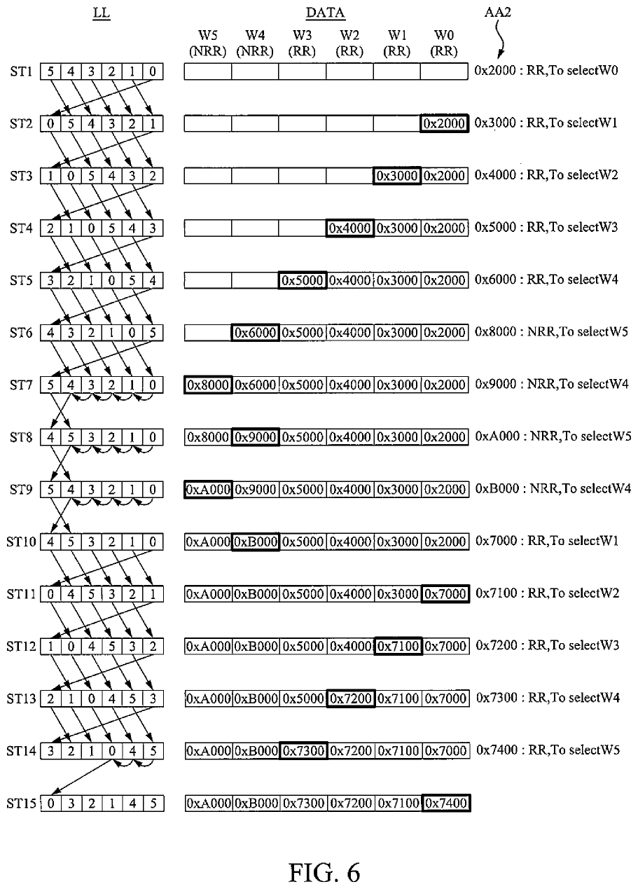

Reference is made to FIG. 2 again. The logic circuit 121 is configured to output a selection signal S1 according to an access address of the data to be read in the main memory 160 (e.g., the access address AA2 in FIG. 6), the restricted region of the main memory 160, and the mode setting information MODE. The selection signal S1 is to select one of the ways W0-W3 as a selected way, in order to write the data corresponding to the access address into the selected way.

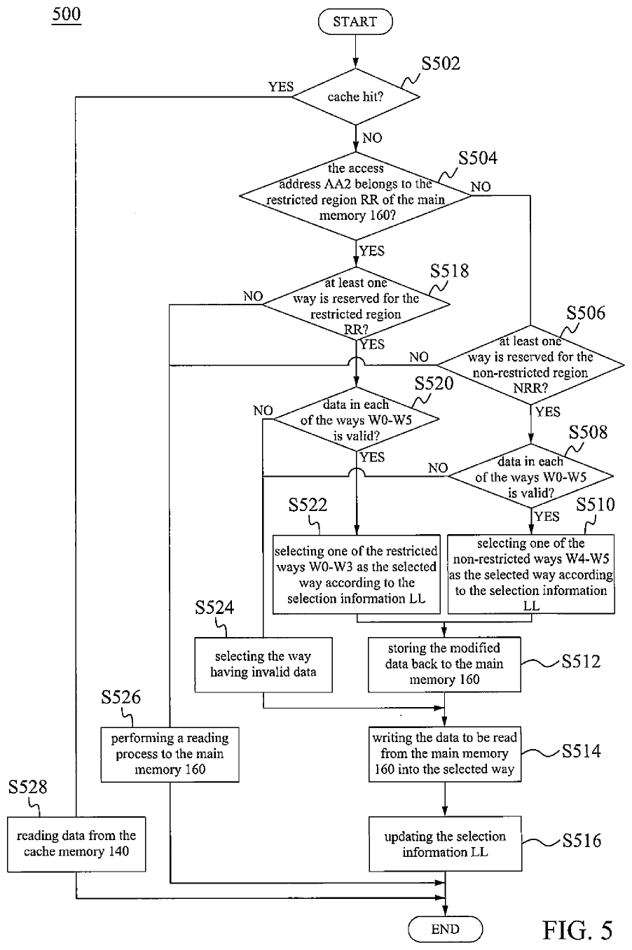

References are made to FIG. 5 and FIG. 6. FIG. 5 is a flow diagram illustrating an operation method 500 of a data write system according to some embodiments of the present disclosure. FIG. 6 is a schematic diagram illustrating operations of the operation method 500 in FIG. 5 according to some embodiments of the present disclosure. In some embodiments, the operation method 500 is applied to the data write system 100 in FIG. 1, but the present disclosure is not limited thereto. As illustrated in FIG. 5, the operation method 500 includes operations S502, S504, S506, S508, S510, S512, S514, S516, S518, S520, S522, S524, S526 and S528. FIG. 6 illustrates steps ST1-ST15. In the following paragraphs, FIG. 5 and FIG. 6 are both used to explain the operation method 500.

In operation S502, it is determined whether “cache hit” occurs. If yes, the operation method 500 goes to operation S528. If “cache hit” occurs, it indicates that the data to be read exists in the cache memory 140, so the data is read from the cache memory 140 directly. If “cache hit” does not occur, it indicates “cache miss” occurs. In other words, the data to be read does not exist in the cache memory 140. Then, the operation method 500 goes to operation S504.

In operation S504, the logic circuit 121 determines whether the access address AA2 belongs to the restricted region RR (defined by the base address information BA and the top address information TA) of the main memory 160. As illustrated in the step ST1 in FIG. 6, the logic circuit 121 determines that the access address AA2 (0x2000) belongs to the restricted region RR. Then, the operation method 500 goes to operation S518.

In operation S518, the logic circuit 121 determines whether at least one way is reserved for the restricted region RR. For example, if the mode setting information MODE records that the ways W0-W3 are restricted ways and the ways W4-W5 are non-restricted ways, it indicates that there is at least one way (restricted way) is reserved for the restricted region RR. Then, the operation method 500 goes to operation S520. If there is no way reserved for the restricted region RR (for example, the ways W0-W5 are the non-restricted ways), the operation method 500 goes to operation S526.

In operation S526, the core processing circuit 120 performs a reading process to the main memory 160. In other words, the core processing circuit 120 reads “the data to be read” from the main memory 160.

In operation S520, the logic circuit 121 determines whether there is valid data in each of the ways W0-W5. As illustrated in step ST1 in FIG. 6, there is no valid data in the restricted way W0. In other words, the data in the restricted way W0 is not valid. Then, the operation method 500 goes to operation S524.

In operation S524, the logic circuit 121 selects the restricted way W0 as the selected way. Then, the operation method 500 goes to operation S514, to write the data to be read from the main memory 160 into the selected way. In other words, the data corresponding to the access address AA2 (0x2000) is written into the way W0 of the cache memory 140, as illustrated in step ST2 in FIG. 6. Thus, the core processing circuit 120 can read “the data to be read” directly from the cache memory 140 which is with a faster operation speed.

Then, the operation method 500 goes to operation S516, to update the selection information LL in FIG. 6. In other words, the way W0 just used is updated to the end of the selection information LL (shown on left side of FIG. 6).

There are similar operations in steps ST2-ST4, so they are not described herein again. In some embodiments, as illustrated in steps ST5-ST6 in FIG. 6, there is no valid data in the way W4 (that is, the determination of operation S520 is “no”) in step ST5, so the way W4 is selected as the selected way (operation S524). Even if the way W4 is the non-restricted way, the data of the access address AA2 (0x6000) is still written into the non-restricted way W4 in step ST6 (operation S514).

Back to operation S504. As illustrated in step ST6 in FIG. 6, if the logic circuit 121 determines that the access address AA2 (0x8000) belongs to the non-restricted region NRR of the main memory 160, the operation method 500 goes to operation S506.

In operation S506, the logic circuit 121 determines whether at least one way is reserved for the non-restricted region NRR. For example, if the mode setting information MODE records that the ways W0-W3 are the restricted ways, and that the ways W4-W5 are the non-restricted ways, it indicates that there is at least one way (non-restricted way) reserved for the non-restricted region NRR. Then, the operation method 500 goes to operation S508. If there is no way reserved for the non-restricted region NRR (for example, the ways W0-W5 are restricted ways), the operation method 500 goes to operation S526.

In operation S526, the core processing circuit 120 performs a reading process from the main memory 160. In other words, the core processing circuit 120 reads “the data to be read” from the main memory 160.

In operation S508, the logic circuit 121 determines whether there is valid data in each of the ways W0-W5. As illustrated in step ST6 in FIG. 6, there is no valid data in the non-restricted way W5. In other words, data in the non-restricted way W5 is not valid (that is, invalid), Then, the operation method 500 goes to operation S524.

In operation S524, the logic circuit 121 selects the non-restricted way W5 as the selected way. Then, the operation method 500 goes to operation S514, to write the data to be read from the main memory 160 into the selected way. In other words, the data corresponding to the access address AA2 (0x8000) is written into the non-restricted way W5 of the cache memory 140, as illustrated in step ST7 in FIG. 6. Thus, the core processing circuit 120 can read “the data to be read” directly from the cache memory 140 which is with a faster operation speed.

In some embodiments, if the access address AA2 belongs to the non-restricted region NRR of the main memory 160, and if there is no valid data in at least one of the ways W0-W3 (that is, the determination of operation S508 is “no”), the at least one way is selected as the selected way (operation S524). Even if the selected way is the restricted way, the data corresponding to the access address AA2 is still written into the restricted way (operation S514).

Then, the operation method 500 goes to operation S516 to update the selection information LL in the FIG. 6. In other words, the way W5 just used is updated to the end of the selection information LL (shown on left side of FIG. 6).

Back to operation S508, if the logic circuit 121 determines that there is valid data in each of the ways W0-W5, the operation method 500 goes to operation S510. In operation S510, the logic circuit 121 selects one of the non-restricted ways W4-W5 as the selected way according to the selection information LL. As illustrated in step ST7 in FIG. 6, the logic circuit 121 determines that the access address AA2 (0x9000) belongs to the non-restricted region NRR, and the data in the ways W4-W5 are valid. Thus, the logic circuit 121 selects one of the non-restricted ways W4-W5 to write the data corresponding to the access address AA2 (0x9000). If the selection information is corresponding to the LRU algorithm, the logic circuit 121 selects one which is least recently used from the non-restricted ways W4-W5 as the selected way. Since the non-restricted way W4 is the least recently used one of the non-restricted ways W4-W5, the logic circuit 121 selects the non-restricted way W4 as the selected way.

Then, the operation method 500 goes to operation S512. If the data has been modified, the modified data is required to be stored back to the main memory 160. Then, the operation method 500 goes to operation S514 to write data to be read from the main memory 160 into the selected way of the cache memory 140. In other words, the data corresponding to the access address AA2 (0x9000) is written into the non-restricted way W4 of the cache memory 140, as illustrated in step ST8 in FIG. 6. Thus, the core processing circuit 120 can read “the data to be read” directly from the cache memory 140 which is with a faster operation speed.

Then, the operation method 500 goes to operation S516 to update the selection information LL in the FIG. 6. In other words, the way W4 just used is updated to the end (left side shown in FIG. 6) of the selection information LL.

Back to operation S520, if the logic circuit 121 determines that there is valid data in each of the ways W0-W5, the operation method 500 goes to operation S522. In operation S522, the logic circuit 121 selects one of the restricted ways W0-W3 as the selected way according to the selection information LL. As illustrated in step ST10 in FIG. 6, the logic circuit 121 determines that the access address AA2 (0x7000) belongs to the restricted region RR, and that the data in the restricted ways W0-W3 is valid. Thus, the logic circuit 121 selects one of the restricted ways W0-W3 to write the data corresponding to the access address AA2 (0x7000). If the selection information is corresponding to the LRU algorithm, the logic circuit 121 selects one which is least recently used from the restricted ways W0-W3 as the selected way. Since the restricted way W0 is the least recently used one of the restricted ways W0-W3, the logic circuit 121 selects the restricted way W0 as the selected way.

Then, the operation method 500 goes to operation S512. If the data has been modified, the modified data is required to be stored back to the main memory 160. Then, the operation method 500 goes to operation S514 to write the data to be read in the main memory 160 into the selected way. In other words, the data corresponding to the access address AA2 (0x7000) is written into the restricted way W0 of the cache memory 140, as illustrated in step ST11 in FIG. 6. Thus, the core processing circuit 120 can read “the data to be read” directly from the cache memory 140 which is with a faster operation speed.

Then, the operation method 500 goes to operation S516 to update the selection information LL in the FIG. 6. In other words, the way W0 just used is updated to the end of the selection information LL.

Based on the descriptions above, by setting the restricted ways and the non-restricted ways and with a specific written method, the data in the restricted region RR and the data in the non-restricted region NRR do not interfere to each other. For example, if a system is running a program A in the restricted region RR, it does not affect a program B in the non-restricted region NRR. Accordingly, the cache hit rate of the restricted region RR and the cache hit rate of the non-restricted region NRR can be maintained respectively.

In addition, by the operations above, the present disclosure does not lock data and does not perform an initialization process. Thus, the cache memory 140 is utilized more effectively. In addition, by utilizing the base address information BA and the top address information TA to define the restricted region RR, in some embodiments, the restricted region RR of the present disclosure is larger than the non-restricted region NRR.

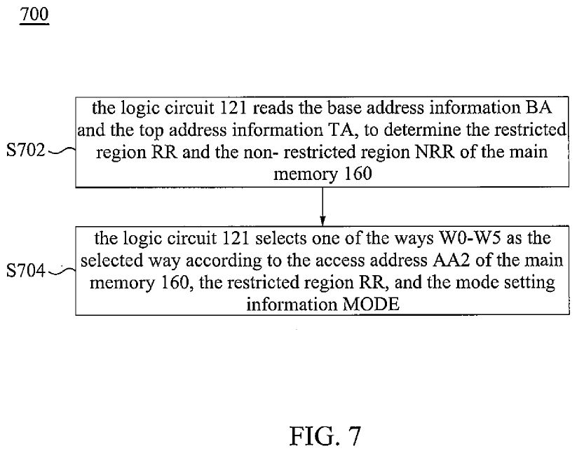

Reference is made to FIG. 7. FIG. 7 is a flow diagram illustrating a data write method 700 according to some embodiments of the present disclosure. The data write method 700 includes operations S702 and S704. The data write method 700 may be applied to the data write system 100 in FIG. 1, but the present disclosure is not limited thereto. For better understanding of the present disclosure, the data write method 700 is discussed with reference to FIG. 1, FIG. 2, and FIG. 6.

In operation S702, the logic circuit 121 of the core processing circuit 120 reads the base address information BA and the top address information TA, to determine the restricted region RR and the non- restricted region NRR of the main memory 160. The base address information BA is stored in the register R1. The top address information TA stored in the register R2. In some embodiments, the main memory 160 has multiple restricted regions RR.

In operation S704, the logic circuit 121 selects one of the ways W0-W5 in FIG. 6 as the selected way, to write data corresponding to the access address AA2 into the selected way according to the access address AA2 of the main memory 160, the restricted region RR, and the mode setting information MODE. In some embodiments, the logic circuit 121 selects the one of the ways W0-W5 according to the LRU algorithm.

As shown in the above embodiments, the data write system and the data write method of the present disclosure can prevent data in the restricted region and data in the non-restricted region from interfering each other.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuity in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A data write system, comprising:
a main memory, comprising a restricted region and a non-restricted region;
a cache memory, coupled to the main memory, wherein the cache memory comprises a plurality of ways; and
a core processing circuit coupled to the cache memory, wherein the core processing circuit comprises a logic circuit, wherein the logic circuit is configured to select one of the ways as a selected way according to an access address of the main memory, the restricted region, and mode setting information, to write data corresponding to the access address into the selected way.

2. The data write system of claim 1, further comprising:
a first register configured to store base address information; and
a second register configured to store top address information,
wherein the restricted region is defined by the base address information and the top address information.

3. The data write system of claim 1, further comprising:
a register configured to store the mode setting information, wherein the mode setting information records that each of the ways is a restricted way or a non-restricted way.

4. The data write system of claim 1, wherein when a cache miss occurs, the logic circuit determines whether the access address belongs to the restricted region, wherein when the access address belongs to the restricted region, the logic circuit determines whether there is at least one restricted way, wherein when there is the at least one restricted way, the logic circuit determines data in each of the ways is valid, wherein if yes, the logic circuit selects one of the at least one of restricted ways to be the selected way.

5. The data write system of claim 4, wherein the logic circuit selects least recently used (LRU) one of the at least one of restricted ways to be the selected way according to a LRU algorithm.

6. The data write system of claim 5, wherein when the data corresponding to the access address is written into the selected way according to the LRU algorithm, selection information is updated.

7. The data write system of claim 4, wherein when the logic circuit determines that invalid data is in the ways, the logic circuit selects at least one way corresponding to the invalid data to be the selected way.

8. The data write system of claim 4, wherein when the logic circuit determines that there is no restricted way, the core processing circuit performs a reading process to the main memory.

9. The data write system of claim 1, wherein when a cache miss occurs, the logic circuit determines whether the access address belongs to the non-restricted region, wherein when the access address belongs to the non-restricted region, the logic circuit determines whether there is at least one non-restricted way, wherein when there is the at least one non-restricted way, the logic circuit determines data in each of the ways is valid, wherein if yes, the logic circuit selects one of the at least one of non-restricted ways to be the selected way.

10. The data write system of claim 9, wherein the logic circuit selects LRU one of the at least one of non-restricted ways to be the selected way according to the LRU algorithm.

11. The data write system of claim 9, wherein when the logic circuit determines that there is invalid data in the ways, the logic circuit selects at least one way corresponding to the invalid data to be the selected way.

12. The data write system of claim 9, wherein when the logic circuit determines that there is no non-restricted way, the core processing circuit performs a reading process to the main memory.

13. A data write method, comprising:
reading base address information and top address information by a logic circuit of a core processing circuit, to determine a restricted region and a non-restricted region of a main memory; and
selecting one of a plurality of ways of a cache memory as a selected way according to an access address of the main memory, the restricted region, and mode setting information by the logic circuit, to write data corresponding to the access address into the selected way.

14. The data write method of 13, further comprising:
when a cache miss occurs, determining whether the access address belongs to the restricted region by the logic circuit;
when the access address belongs to the restricted region, determining whether there is at least one restricted way by the logic circuit;
when there is the at least one restricted way, determining data in each of the ways is valid by the logic circuit; and
if yes, selecting one of the at least one of restricted ways to be the selected way by the logic circuit.

15. The data write method of 14, wherein selecting the one of the at least one of restricted ways to be the selected way by the logic circuit comprises:
selecting LRU one of the at least one of restricted ways to be the selected way according to a LRU algorithm by the logic circuit.

16. The data write method of claim 15, further comprising:
when the data corresponding to the access address is written into the selected way according to the LRU algorithm, updating selection information.

17. The data write method of 14, further comprising:
when the logic circuit determines that invalid data is in the ways, selecting at least one way corresponding to the invalid data to be the selected way by the logic circuit.

18. The data write method of 14, further comprising:
when the logic circuit determines that there is no restricted way, performing a reading process to the main memory by the core processing circuit.

19. The data write method of 13, further comprising:
when a cache miss occurs, determining whether the access address belongs to the non-restricted region by the logic circuit;
when the access address belongs to the non-restricted region, determining whether there is at least one non-restricted way by the logic circuit;
when there is the at least one non-restricted way, determining data in each of the ways is valid by the logic circuit; and
if yes, selecting one of the at least one of non-restricted ways to be the selected way by the logic circuit.

20. The data write method of 19, wherein selecting one of the at least one of non-restricted ways to be the selected way by the logic circuit comprises:
selecting LRU one of the at least one of non-restricted ways to be the selected way according to the LRU algorithm by the logic circuit.
